(19) United States
(12) Patent Application Publication
(10) Pub. No.: US 2008/0259800 A1
(43) Pub. Date: Oct. 23, 2008

(54) Method and System for Correlating Streams within a Packet Network

(76) Inventors: Alan Clark, Snellville, GA (US); Shane Holthaus, Cumming, GA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/103,360

(22) Filed: Apr. 15, 2008

Related U.S. Application Data
(60) Provisional application No. 60/911,991, filed on Apr. 16, 2007.

(51) Int. Cl. H04L 12/26

(52) U.S. Cl. 370/235

(57) ABSTRACT

A method and system for correlating data streams within a packet network. The method relies on independently selecting the same packets as reference packets at different places and times within the network. Once selected, the data contained in a given reference packet is utilized to generate a unique tag for that reference packet. This tag can later be compared with other tags generated at other places and times within the network to track the reference packet and its containing stream as it travels over the network.

### CROSS-REFERENCE TO RELATED APPLICATIONS

This application claims priority to U.S. provisional application No. 60/911,991, filed Apr. 16, 2007, which is incorporated herein by reference.

### BACKGROUND OF THE INVENTION

The present invention relates to a method and system for correlating streams within a packet network.

Today's packet networks are carrying an ever-increasing amount of data, including video and voice traffic. In order to ensure a high quality of service over such packet networks, it is necessary to deploy probes or monitoring devices that can monitor traffic at various points within a network to observe traffic patterns and gather performance metrics. Such probes need to be able to uniquely identify the data streams that they observe and share that identification information with other probes or higher management systems. Uniquely identifying data streams on a packet network can be difficult, however, and the present invention describes a system and method for doing so.

It is common with current Internet Protocol (“IP”) networks, including the public Internet, to identify a data stream utilizing a pair of endpoints—the source endpoint and destination endpoint. Each endpoint contains the IP address of the source or destination device along with the UDP (User Datagram Protocol) or TCP (Transmission Control Protocol) port on which communications are sent or received. For example, a stream might originate from source device “A” with IP address of 1.2.3.4 on UDP port 2000 and terminate on destination device “B” with IP address of 5.6.7.8 at UDP port 5000. Such a stream would typically be identified by the following endpoint pair:

Source (A)=1.2.3.4:2000

Destination (B)=5.6.7.8:5000

However, certain types of routers, including firewall routers with Network Address Translation (“NATS”) and Session Border Controllers, will intercept data streams and modify the source and/or destination endpoints. For instance, a NATS router “R” might intercept the above-identified stream before it reached destination “B” and modify the destination IP address and port number. Thus, the identical stream would be identified by two different endpoint pairs, one from source “A” to router “R” and one from router “R” to destination “B”:

Segment of stream from A to R:
Source=1.2.3.4:2000
Destination=5.6.7.8:5000

Segment of stream from R to B:
Source=99.22.33.44:6000
Destination=5.6.7.8:5000

Additional routers or other devices in the network could repeat the process many times, modifying the source and/or destination endpoint each time. Thus, if multiple probes or monitoring devices are placed at various points within a packet network, each probe might detect different endpoint pairs for the same data stream. This makes it difficult for such probes (or any other monitoring system) to compare various streams and determine which ones are carrying the same data. This difficulty in correlating streams, in turn, makes it difficult for systems to evaluate the quality of service delivered over such packet networks including whether the networks are losing packets or delaying the delivery of packets.

Prior systems have addressed this problem by reading identification information from the signaling protocol utilized to establish communications between the initial source and the ultimate destination. However, signaling protocols can be encrypted, thereby preventing probes within a network from reading the identification information contained in them. Furthermore, signaling protocol messages typically travel from source to destination by a different route than the accompanying data stream. Thus, a probe monitoring a given data stream might not have access to the accompanying signaling protocol.

### SUMMARY OF THE INVENTION

The present invention allows for the correlation of streams within a packet network without utilizing the IP address/port endpoint pairs or the signaling protocol. It does so by calculating a Reference Packet Identification Tag (“RPIT”) at selectively varying intervals for a given data stream. The selectively varying interval is configured so that each one of a plurality of probes within a packet network can independently identify a plurality of “reference packets” within a data stream. For instance, a first probe in an embodiment of the invention could analyze a sequence number contained in every packet that passes by its location in the network and select every 1024^{th} packet (with a sequence number equal to a multiple of 1024) as a reference packet. Likewise, a second probe could analyze the sequence numbers in the packets that pass by its location and select every 1024^{th} packet (with a sequence number equal to a multiple of 1024) as a reference packet. Thus, the two probes could independently find the same reference packets for a given stream.

After identifying a given reference packet, a probe in an embodiment of the invention could calculate an RPIT based on the payload data or certain immutable packet header data contained within the reference packet. The algorithm utilized to generate the RPIT could be any of a variety of well-known algorithms for generating a checksum. Alternatively, the algorithm could be a hash function or any other function that could generate sufficiently unique RPITs based on the payload data of packets traveling in the network. Because the packets' payload data is generally not altered by routers or other devices within a packet network, each of the plurality of probes will, when utilizing the same RPIT function, generate an identical RPIT for a given reference packet whenever that packet is observed at a particular probe's location.

For instance, after identifying a certain reference packet with a sequence number of 1024, a first probe in an embodiment of the invention could calculate an RPIT checksum based on the payload data stored in the reference packet. Similarly, a second probe in an embodiment of the invention could utilize the same checksum algorithm to calculate an RPIT based on the payload data when it observes a reference packet with a sequence number of 1024. If the data stream that passed by the first probe is the same stream that passed by the second probe, then the RPITs generated by the probes will be identical. This is because the probes are utilizing identical functions for calculating the RPIT and because the routers in the network will generally not alter the data payload of the packets. If, however, the first and second probes calculate different RPITs for the reference packets respectively containing a sequence number of 1024, then it must be that these reference packets belong to different data streams.

Some packet networks will contain decoders or transcoders that can alter the data payloads of the various packets traveling over the network. In such a case, probes in some embodiments of the invention will decode the payloads of the packets and quantize the decoded signal before calculating the RPIT. This will ensure that the identical RPIT is generated for a given reference packet by all the probes that encounter that reference packet.

As an alternative to utilizing the data payload to calculate the RPITs, the probes in embodiments of the invention could instead utilize packet header information so long as that information is not modified by routers or other devices in the network.

After calculating an RPIT for a given reference packet, a probe of the current invention can send that RPIT in a report to a centralized or distributed Quality-of-Service monitor (“QoS monitor”) for correlating the various streams within the network. The QoS monitor could gather and store such reports and compare the RPITs contained in various reports to find matches. Matching RPITs in various reports from different probes would indicate that a common data stream had passed by those particular probes.

A probe of the present invention could also gather network performance metrics and include them in the reports that the probe sends to the QoS monitor. These performance metrics could include things such as data throughput, lost packets, and packet delay. The association of performance metrics with an RPIT will allow the QoS monitor to determine how various data streams are traveling through a network. For instance, the QoS monitor could determine if packets were being dropped at a particular point in the network or could locate traffic bottlenecks within the network. Such information would be useful for analyzing the quality of service delivered by the network and improving the data traffic flow within the network.

A probe of the current invention could also send certain diagnostic information to the QoS monitor. Such information could include a date/time stamp of the date and time when the probe encountered a particular reference packet. This information would be useful in determining the time delays in the network as a particular reference packet traveled from probe to probe. Such diagnostic information could also include a geographic or network location identifier to assist the QoS monitor in locating the source of the report. In addition, a probe could generate a sequence number to associate with each report that it sends to the QoS monitor so that the system can maintain a record of the order in which reference packets were received at each particular probe. Such ordering could be especially helpful in identifying dropped packets by comparing sequence numbers among the various probes.

Some embodiments of the invention could associate two or more RPITs with each reference packet. For instance, in one embodiment of the invention, a probe will calculate a “current” RPIT for the current reference packet as described above, by computing a checksum based on the current reference packet's data payload. The probe will also maintain a copy of the “previous” RPIT that it calculated for the previous reference packet. The probe will then identify the “current” reference packet by the combination of the “current” and “previous” RPITs when sending reports to the QoS monitor. Such an identification system could be extended ad infinitum to include two, three, or N previous RPITs to identify the “current” reference packet.

This use of two (or more) RPITs to identify a single reference packet provides for added redundancy in case a reference packet is dropped by a network and therefore is not detected by a given probe. In such a situation where a given reference packet is dropped, the subsequent reference packet will be identified both by its current RPIT and the RPIT of the reference packet received by the probe before the dropped reference packet. In this manner, the QoS monitor can determine the order of the packets and determine that a packet has been dropped.

### BRIEF DESCRIPTION OF THE DRAWINGS

FIG. 1 is a block diagram of a Quality-of-Service monitoring system in an embodiment of the invention.

FIG. 2 is a flow chart of the steps taken to process an individual probe report in an embodiment of the invention.

### DETAILED DESCRIPTION

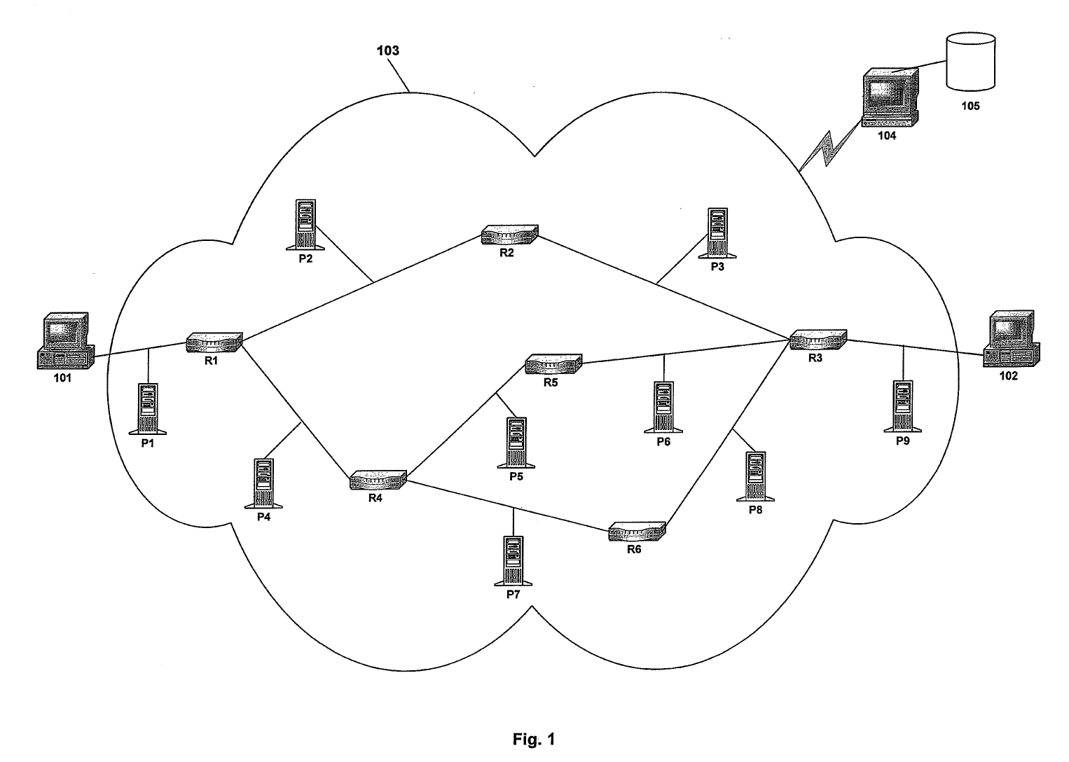

FIG. 1 is a diagram of a system in an embodiment of the invention. In FIG. 1, a source device 101 is sending a series of packets to a destination device 102 over a packet network 103. Such a packet network 103 could comprise the public internet, a private packet network, or some combination of both. The packet network 103 contains several routers R1-R6 to route data traffic through the network 103. In this embodiment, one or more of the routers R1-R6 modifies the source or destination IP address of packets traveling through the router so that it is impossible to determine the identity of the packets on the network based on source/destination IP address alone.

The packet network 103 also contains nine probes P1-P9 in this embodiment of the invention. The probes P1-P9 lie on the network segments between the various routers R1-R6 and monitor the packets that travel along their respective network segments. The probes P1-P9 can be implemented as general purpose computers running software which directs their actions. Alternatively, the probes P1-P9 can be implemented as special-purpose devices including, but not limited to, ROM, RAM, EEPROM, flash memory, or integrated circuit devices. The logic of the probes P1-P9 can be implemented in software, hardware, or some combination of both.

A QoS monitor 104 receives messages (“reports”) from the various probes P1-P9, stores them in its attached persistent storage device 105, and analyzes them in real-time. In this embodiment, the QoS monitor 104 is a general purpose computer running software that receives the probe reports, stores them in a database 105, and analyzes the reports in real-time. In other embodiments, the QoS monitor 104 could be implemented in a special-purpose device including, but not limited to, ROM, RAM, EEPROM, flash memory, or integrated circuit devices. In some embodiments, the persistent storage device 105 could be implemented as a disk hard drive, CD-ROM, DVD-ROM or other optical disc storage, flash memory device, ROM, RAM, EEPROM, floppy disk, magnetic tape, or any similar device. The QoS monitor 104 of some embodiments could delay the analysis of the probe reports instead of analyzing them in real-time. Finally, in some embodiments the QoS monitor 104 may analyze the probe reports in real-time and forego storing the reports in a persistent storage device 105.

Identifying Reference Packets Using Sequence Numbers

The network 103 in this embodiment of the invention carries primarily TCP (Transmission Control Protocol) and RTP (Real-time Transport Protocol) packets. Both TCP and RTP are well-known network communication protocols in the art. Each packet transmitted over a network using TCP or RTP contains a “sequence number” in the respective “header” of the TCP or RTP packet. The sequence number is a 32-bit binary number in the TCP protocol and a 16-bit binary number in the RTP protocol.

The sequence number is utilized to maintain the correct ordering of the packets. A sending device 101 will attach a sequence number to each packet that it sends on the network 103. The first packet in a new data stream will be assigned a beginning sequence number (encoded in binary) by the sending device 101. For each subsequent packet in the data stream, the sending device 101 will increment the sequence number by one and insert the sequence number into the packet header. Because different packets can travel from source 101 to destination 102 by different routes over a network 103, the receiving device 102 can sometimes receive the packets out of order. This could be caused by a bottleneck on one segment of a network delaying the packets that travel over that segment. The destination device 102 will utilize the sequence numbers to compensate for any such delays and place the packets in the proper order.

The probes P1-P9 in this embodiment of the invention will monitor the sequence number of every TCP or RTP packet that travels along their respective positions in the network. The purpose of this monitoring is for the probes P1-P9 to selectively identify certain packets as “reference packets” at regular intervals in a given data stream. In this embodiment, each probe will compare the 10 least significant bits of each observed packet's sequence number to the binary mask containing 10 zeroes (“0000000000”). Any packet whose binary sequence number ends in 10 zeroes will thus be designated a “reference packet”. For a continuous data stream, every 1024^{th} packet will be a reference packet. This is because the binary sequence number will match the 10-bit mask (“0000000000”) after being incremented 1024 times.

This method of identifying reference packets allows for the probes P1-P9 to independently identify the same packets in a data stream as reference packets. Not every probe in the network will encounter every reference packet, however. Only those probes monitoring the network segments over which a given reference packet travels will observe the given reference packet. Since data packets can travel via different routes from sender 101 to receiver 102, different groups of probes may encounter one or more reference packets for a given data stream.

For instance, a data stream might begin by sending its packets from source 101 to destination 102 passing along probes P1, P2, P3, and P9. Any reference packets contained in the stream would thus only be observed by those four probes: P1, P2, P3, and P9. The data stream could subsequently be routed from source 101 to destination 102 passing along probes P1, P4, P7, P8, and P9. Any reference packets contained in the data stream would then be observed only by these five probes: P1, P4, P7, P8, and P9.

It should be noted that this method will not document every single route taken by a packet from source 101 to destination 102. For example, a very few number of packets (or even a single packet) of the data stream might travel along the route passing by probes P1, P4, P5, P6, and P9. If this few number of packets did not contain a reference packet, then these five probes would not take notice of the path traveled from source 101 to destination 102. Conversely, a given reference packet could by chance be routed along a path that few (or none) of the other data packets in the stream traveled over. In such a case, the probes along this path would observe and record that a reference packet traveled over that path. Such pathological situations can be minimized by increasing the frequency with which reference packets are identified. For example, a nine-bit mask would identify every 512^{th} packet in a data stream as a reference packet instead of every 1024^{th} packet as described above. This approach would increase the number of probe reports, however, and tax the computational power of the QoS monitor 104 and the storage capacity of the persistent storage device 105.

An embodiment of the invention could even treat every packet as a reference packet and thus forego the above-described method of selecting reference packets utilizing sequence numbers and a binary mask. This embodiment would have the drawback that it greatly increases the number of reports being sent from probes to the QoS monitor 104, thus clogging the network 103 with excess traffic. In addition, this embodiment would tax the computational capacity of the QoS monitor 104, which would have to process the large number of probe reports. Finally, the persistent storage device 105 would need to be large in order to store all of the probe reports.

Identifying Reference Packets Using RTP Timestamp Field

A different embodiment of the invention could utilize the “timestamp” field contained in RTP packet headers to identify the reference packets. Each RTP packet contains a 32-bit timestamp value. The timestamp indicates when a given packet should be played back in real-time relative to the other packets.

Typically, voice or video data will be segmented into a series of “frames”, each of which represents a discrete unit. Each frame will be further segmented into smaller packets for transmission over the network 103. All packets of a given frame will contain the same timestamp value. Conversely, packets of different frames will have different timestamps. Because most frames are played back at regular intervals, the timestamps in successive groups of packets will be multiples of a base factor. To identify reference packets using the RTP timestamps, the probes P1-P9 would be calibrated based on the frequency of the timestamps.

For example, a given RTP data stream may send out a frame every 10 milliseconds. The clock used to calculate the RTP timestamps may have a frequency of 8 ticks per millisecond. Thus, successive frames in the stream will have binary-equivalent timestamps that are multiples of 80. (This is obtained by multiplying 10 by 8.)

In this example, most frames in the data stream are contained in a single packet. Thus, most packets have a unique timestamp value. However, the data stream may have occasional frames comprising multiple packets with the same timestamp value.

In this example, it is desired that every 1024^{th} packet be designated a reference packet. Since the timestamps generally increase in increments of 80, successive reference packets will contain multiples of 81,920. (This is obtained by multiplying 1024 by 80.)

Thus, probes P1-P9 will designate every packet with a binary-equivalent timestamp that is a multiple of 81,920 as a reference packet. This could be accomplished by the modular division of each packet's timestamp value by 81,920 and determining if there was any remainder. If there is no remainder, then the packet's timestamp is a multiple of 81,920 and thus is a reference packet.

As described earlier, several packets in a row may have the same timestamp because they comprise the same frame. If such a timestamp were a multiple of 81,920, then all of those packets would be designated as reference packets.

Those skilled in the art will recognize that some RTP data streams may not contain timestamps at such regular intervals. As such, this method of designating reference packets is less precise than using sequence numbers.

Identifying Reference Packets Using Payload Tags

Another embodiment of the invention could identify reference packets using a “payload tag” instead of the sequence numbers or timestamps described above. Such a payload tag could be generated by the sending device 101 or a “master” probe P1 that observed all or substantially all of the packets in a given data stream. A payload tag could be generated, for example, by simply reading the first 16 bits (“payload tag field”) of the data payload in a given packet.

The sending device 101 or master probe P1 would need to calculate payload tags at regular intervals for the packets being sent over the network. This could be accomplished, for example, by simply counting the packets that were sent by the sending device 101 and designating every 1024^{th} (or other suitable interval) packet as a reference packet. Alternatively, the sending device 101 or master probe P1 could utilize a clock to wait a period of 60 seconds, for example, and then designate the next packet sent by the sending device 101 as a reference packet.

After designating a given packet as a reference packet and generating a corresponding payload tag for that packet, the sending device 101 or master probe P1 could communicate the payload tag to the other “servant” probes P2-P9 in the network. These servant probes P2-P9 would store these payload tags in memory or some persistent storage device. The servant probes P2-P9 would monitor the payload tag fields of every packet they observed on the network and compare the data stored in those fields with the previously calculated payload tags. If a given servant probe (P4, e.g.) observed that the data in a given packet's payload tag field matched a payload tag, then the servant probe P4 would record that the packet was a reference packet.

Calculating Reference Packet Identification Tags (RPITs)

When a given probe (P4, e.g.) encounters a reference packet, the probe P4 will then calculate a Reference Packet Identification Tag (RPIT) based on the contents of the reference packet. The probe P4 can use any of a variety of algorithms to generate the RPIT. For instance, the probe P4 could use a checksum algorithm such as MD5. Or the probe P4 could use a hash function or any other function that is capable of generating sufficiently unique output values. The purpose of the RPIT is to uniquely identify a given reference packet (and hence the stream of which it is a part) as that reference packet travels over the network 103. That is, the RPIT-generating function should produce a different result for different reference packets. But the RPIT-generating function should produce the same result for the same reference packet at different locations within the network 103.

In order to maintain a consistent RPIT for a given reference packet, the input to the RPIT-generating function must not change as the reference packet travels through the network 103. For instance, the packet data used by probe P4 to generate an RPIT for a given reference packet must not be altered by router R4 before the reference packet reaches probe P7. Because router R4 might alter the reference packet's source IP address or destination IP address, it would be unsuitable for probe P7 to rely on either of these IP addresses to calculate the RPIT. Instead, probe P7 should rely on data within the reference packet that will not be altered by router R4.

In some embodiments of the invention, probe P7 will utilize the data payload portion of the reference packet to calculate the RPIT. Routers do not generally modify the data payload of packets because doing so would corrupt the message that is being sent from sender 101 to receiver 102. Thus, probe P7 can be assured that router R4 had not modified the payload of the reference packet as it traveled through router R4.

Some packet networks will contain decoders or transcoders that can alter the data payloads of the various packets traveling over the network, however. In such a case, some embodiments of the invention will decode the payloads of the packets and quantize the decoded signal before calculating the RPIT. This will ensure that the identical RPIT is generated for a given reference packet by all the probes that encounter that reference packet.

Embodiments utilizing the payload portion of the reference packet to calculate the RPITs could use all of the payload or only a selected portion of the payload. For instance, the probes P1-P9 in one embodiment of the invention could utilize only the first 100 bytes of the data payload when calculating RPITs. If a given reference packet contained less than 100 bytes in the data payload, then the probes P1-P9 in this embodiment would utilize the entire data payload to calculate the RPIT.

Alternatively, the probes in other embodiments would always use the entire payload to generate an RPIT. In one such embodiment, the data payload of a given reference packet would be grouped into a series of 24-bit numbers, discarding any remaining bits at the end of the payload. These 24-bit numbers would then be added together and the sum would be modulo-divided by 32. That is, the sum would be divided by 32 and the remainder would be used as the RPIT for that particular reference packet.

In some embodiments of the invention, certain packet header information could be used when calculating RPITS, so long as the routers R1-R6 in the network 103 did not modify the chosen header information. For instance, in some embodiments, the “Synchronization source” (SSRC) header field of an RTP packet could be used to calculate the RPITs. The SSRC field (or any other immutable header field) could be used alone or in conjunction with the payload of the packets. This method has the disadvantage that the SSRC value can change during a voice or video call.

Measuring Performance Metrics

The probes P1-P9 will also gather performance metrics related to the performance of the network 103 in embodiments of the invention. These performance metrics will later be sent to the QoS monitor 104 to help it monitor the quality of service provided by the various components of the network 103. Such performance metrics can include, for example, data throughput, the number and timing of lost packets, and the frequency and amount of any packet delay. For instance, a probe (P4, e.g.) of the invention could record an average throughput rate on its segment of the network of 50 packets per second. The probe P4 could also record that five packets had been dropped on its network segment and record the time that they were dropped. It could also record that its network segment became congested at 10:34:47 a.m. and remained congested for 60 seconds, causing an average packet delay of 30 ms.

Sending Probe Reports

After calculating an RPIT for a given reference packet, a probe (P4, e.g.) of the invention will send a report to the QoS monitor 104. Such a report will contain the RPIT and any performance metrics or other information pertinent to the data stream that carried the reference packet. Such report data can include any or all of the previously described performance metrics. It can also include a date/time stamp that the reference packet was observed by the probe P4. This date/time stamp is not to be confused with the RTP timestamp field described earlier. Rather, this date/time stamp is a representation of the actual date and time that the reference packet was observed, not an elapsed time indicator like the RTP timestamp field. Probe reports in some embodiments of the invention will also include a geographic or network location identifier. This will assist the QoS monitor 104 in locating the physical or logical location of the report within the network 103.

In some embodiments of the invention, each probe will send, in addition to the current reference packet's RPIT, one or more RPITs from previously observed reference packets. This will aid the QoS monitor 104 in detecting dropped packets.

In some embodiments, each probe will include in its probe reports the source and/or destination IP addresses observed in the reference packets. While such IP addresses can be changed or aliased by a NATS router, e.g., the observed IP addresses can still be utilized by the QoS monitor 104 to detect when streams begin and end.

The following table illustrates the data that could be sent by the various probes P1-P9 in one embodiment of the invention. For readability, the RPIT field has been abstracted as a single letter to indicate a unique RPIT value. This example is of two data streams being sent from sender 101 to receiver 102. The first data stream is long enough to contain three reference packets: X, G, and Q. The second data stream is slightly shorter and contains only two reference packets: M and L. It will be recognized that the first transmission of reference packet “L” was dropped somewhere in the network 103 after reaching probe P4. It will be further recognized that the sender 101 re-transmitted reference packet “L”, which successfully reached probe P9 and presumably continued on to the receiver 102.

In this example, the “Report Number” indicates the order in which the report was received by the QoS monitor 104. The “Probe Number” represents the number of the probe (P1-P9) that sent the report. The “Report Sequence Number” is a sequence number added by each probe to uniquely identify a report for that given probe. (The combination of Probe Number and Report Sequence Number will uniquely identify a report among all the reports sent to the QoS monitor 104.) For readability, the date/time stamp field has been abstracted to “<date/time>”. This field would contain an actual numerical representation of the date and time that the particular probe observed the reference packet. Finally, the reports in this example contain “Throughput” and “Packet Delay” fields which respectively indicate the throughput and packet delay present on the network segment observed by a particular probe at the time it observed the reference packet. Such values could represent an instantaneous measurement of the throughput and packet delay. Alternatively, the values could represent a weighted average of recent values on the network segment.

TABLE 1
Probe reports [Embodiment #1]

| | | | | | Throughput | |
|---|---|---|---|---|---|---|
| Report | Probe | Report Sequence | | | [packets per | Packet Delay |
| Number | Number | Number | RPIT | Date/Time | second] | [milliseconds] |
| 1 | 1 | 1 | X | <date/time> | 50 | 0 |
| 2 | 2 | 1 | X | <date/time> | 45 | 2 |
| 3 | 3 | 1 | X | <date/time> | 47 | 10 |
| 4 | 9 | 1 | X | <date/time> | 47 | 5 |
| 5 | 1 | 2 | G | <date/time> | 53 | 1 |
| 6 | 2 | 2 | G | <date/time> | 52 | 1 |
| 7 | 3 | 2 | G | <date/time> | 58 | 7 |
| 8 | 9 | 2 | G | <date/time> | 60 | 6 |
| 9 | 1 | 3 | Q | <date/time> | 57 | 0 |
| 10 | 4 | 1 | Q | <date/time> | 15 | 220 |
| 11 | 7 | 1 | Q | <date/time> | 8 | 577 |
| 12 | 8 | 1 | Q | <date/time> | 8 | 505 |
| 13 | 9 | 3 | Q | <date/time> | 38 | 25 |
| 14 | 1 | 4 | M | <date/time> | 55 | 1 |
| 15 | 2 | 3 | M | <date/time> | 48 | 3 |
| 16 | 3 | 3 | M | <date/time> | 50 | 3 |
| 17 | 9 | 4 | M | <date/time> | 42 | 7 |
| 18 | 1 | 5 | L | <date/time> | 48 | 0 |
| 19 | 4 | 2 | L | <date/time> | 2 | 878 |

<packet L dropped>

| | | | | | | |
|---|---|---|---|---|---|---|
| 20 | 1 | 6 | L | <date/time> | 48 | 1 |
| 21 | 2 | 4 | L | <date/time> | 45 | 5 |
| 22 | 3 | 4 | L | <date/time> | 52 | 5 |
| 23 | 9 | 5 | L | <date/time> | 49 | 3 |

From the reports shown in table 1, it is apparent that packet “L” was dropped somewhere in the network after reaching probe P4 and later re-transmitted. The re-transmission of packet “L” can be deduced from the fact that probe P1 received the “L” packet twice: once in report number 18 and again in report number 20. Since probe P4, in report number 19, was the last probe to detect the “L” packet before its re-transmission was detected, it can be deduced that the original “L” packet was dropped in the network somewhere after probe P4.

It is also apparent from the above probe reports that probes P4, P7, and P8 are experiencing low throughput and high packet delay. This data can aid the QoS monitor 104 in detecting bottlenecks in the network 103.

In a second embodiment, the probes P1-P9 include in their reports both the “current” and the “previous” RPIT for reference packets in the stream. The current RPIT is calculated based on the current reference packet and the previous RPIT field is populated with the previous packet's “current” RPIT. In this embodiment, the probes P1-P9 will maintain a record of the previous RPIT so they can send it in their reports. This will aid the QoS monitor 104 in diagnosing dropped packets, especially with data streams where dropped packets are not re-transmitted. The following table, similar to Table 1, indicates the data that might be included in the probe reports in this embodiment.

In this example, the sender 101 does not re-transmit packets that are dropped in the network. Thus, an individual probe cannot detect a dropped packet simply by observing the re-transmission of a dropped packet. As described more fully below, the QoS monitor 104 can use the current and previous RPIT data to detect dropped packets or route switching events.

This example contains data from a single stream being sent from sender 101 to receiver 102. The stream is long enough to contain seven reference packets: K, R, P, B, V, C, and L.

TABLE 2
Probe reports [Embodiment #2]

| | | Report | | | | Throughput | |
|---|---|---|---|---|---|---|---|
| Report | Probe | Sequence | previous | | | [packets per | Packet Delay |
| Number | Number | Number | RPIT | RPIT | Date/Time | second] | [milliseconds] |
| 1 | 1 | 1 | <none> | K | <date/time> | 55 | 1 |
| 2 | 2 | 1 | <none> | K | <date/time> | 45 | 5 |
| 3 | 3 | 1 | <none> | K | <date/time> | 47 | 3 |
| 4 | 9 | 1 | <none> | K | <date/time> | 49 | 12 |
| 5 | 1 | 2 | K | R | <date/time> | 43 | 5 |
| 6 | 2 | 2 | K | R | <date/time> | 5 | 433 |

<Packet R dropped>

| | | | | | | | |
|---|---|---|---|---|---|---|---|
| 7 | 1 | 3 | R | P | <date/time> | 55 | 15 |
| 8 | 2 | 3 | R | P | <date/time> | 46 | 5 |
| 9 | 3 | 2 | K | P | <date/time> | 42 | 22 |
| 10 | 9 | 2 | K | P | <date/time> | 42 | 8 |
| 11 | 1 | 4 | P | B | <date/time> | 43 | 14 |
| 12 | 2 | 4 | P | B | <date/time> | 57 | 12 |
| 13 | 3 | 3 | P | B | <date/time> | 55 | 8 |
| 14 | 9 | 3 | P | B | <date/time> | 42 | 6 |

<Route switch>

| | | | | | | | |
|---|---|---|---|---|---|---|---|
| 15 | 1 | 5 | B | V | <date/time> | 55 | 7 |
| 16 | 4 | 1 | <none> | V | <date/time> | 59 | 31 |
| 17 | 5 | 1 | <none> | V | <date/time> | 57 | 27 |
| 18 | 9 | 4 | B | V | <date/time> | 53 | 15 |
| 19 | 1 | 6 | V | C | <date/time> | 54 | 11 |
| 20 | 4 | 2 | V | C | <date/time> | 49 | 8 |
| 21 | 5 | 2 | V | C | <date/time> | 52 | 17 |
| 22 | 9 | 5 | V | C | <date/time> | 58 | 16 |
| 23 | 1 | 7 | C | L | <date/time> | 51 | 12 |
| 24 | 4 | 3 | C | L | <date/time> | 51 | 7 |
| 25 | 5 | 3 | C | L | <date/time> | 53 | 16 |
| 26 | 9 | 6 | C | L | <date/time> | 55 | 25 |

From the reports shown in table 2, the QoS monitor 104 can detect that packets “R” and “B” were either dropped in the network or preceded a route switching event.

In the case of packet “R”, this can be seen because of the mismatch between report number 9 and report numbers 7 and 8. Reports 7 and 8 (from probes P1 and P2) show that packet “P” should be preceded by packet “R”. However, probe P3, in report 9, reported that packet “P” was preceded by packet “K” (not “R”). Thus, packet “R” was either dropped in the network or was followed by a route change event.

In the case of packet “B”, there is a mismatch between report number 16 and report number 15. Report 15 shows that packet “V” should be preceded by packet “B”. However, probe P4, in report 16, reported that packet “V” was not preceded by any packet. Thus, packet “B” was either dropped in the network or was followed by a route change event.

Some embodiments will be able to distinguish between a dropped packet and route change event. For instance, it is apparent from report number 18 that packet “B” was not dropped. Like report number 15, report number 18 shows that packet “V” was preceded by packet “B”. Thus, it can be concluded that packet “B” was not dropped. Rather, packet “V” traveled a different route from sender 101 to receiver 102 than packet “B”.

By contrast, no reports after report number 9 show packet “P” preceded by packet “R”. Thus, it can be concluded that packet “R” was indeed dropped in the network.

Processing and Correlating Probe Reports

The QoS monitor 104 of the invention will receive the aforementioned probe reports. In some embodiments, the QoS monitor 104 will store these probe reports in a persistent storage device 105. In some embodiments, the QoS monitor 104 will periodically purge old data from its persistent storage device 105 for ease of processing and to maintain a manageable amount of data. The QoS monitor 104 will compare the RPITs compared in the various probe reports to correlate the probe reports with one another, determine the routes taken by the various reference packets, and provide diagnostic information regarding the quality of service provided by the network 103. In some embodiments, the QoS monitor 104 will be able to differentiate between different streams. That is, the QoS monitor 104 will be able to compute which data streams are present on a network at any given time.

As an example, in one embodiment, the QoS monitor 104 will have a relational database 105 in which it can store data persistently. The database will have the following four tables for storing data: a Probe_Report table, a Reference_Packet table, a Stream table, and a Retransmitted_Reference_Packet table. The QoS monitor 104 will store data related to each individual probe report in the Probe_Report table. The Reference_Packet table will have an entry for every unique reference packet detected by one or more probes P1-P9 of the invention. This table will allow the QoS monitor 104 to correlate probe reports that relate to the same reference packet as it travels through the network 103. The Stream table will have an entry for every data stream that has been identified by the QoS monitor 104. This table will allow the QoS monitor 104 to correlate probe reports and reference packets that belong to the same stream. The Retransmitted_Reference_Packet is used by the QoS monitor 104 to keep track of reference packets that have been dropped and retransmitted.

The following is a listing of the columns contained in these database tables.

Probe_Report table

Report_ID
Probe_Number
Report_Sequence_Number
RPIT
New_Stream
Date_Time
Throughput
Packet_Delay
Ref_Packet_ID_Fkey

Reference_Packet table

Ref_Packet_ID
RPIT
Dropped
Stream_ID_Fkey

Stream table

Stream_ID
Avg_Throughput
Avg_Packet_Delay
Dropped_Packets

Retransmitted_Reference_Packet table

RPIT
Probe_Number

The first field in the first three tables (Report_ID, Ref_Packet_ID, and Stream_ID) is the primary key of each respective table. The primary key uniquely identifies each record in the database table. The final field (Ref_Packet_ID_Fkey and Stream_ID_Fkey) of the first two tables are foreign keys that refer to the primary key of another table. Ref_Packet_ID_Fkey is a foreign key matching the Ref_Packet_ID field in the Reference_Packet table. Stream_ID_Fkey is a foreign key matching the Stream_ID field in the Stream table. This use of foreign keys is well known in the art and allows the QoS monitor 104 to correlate probe reports, reference packets, and streams with one another.

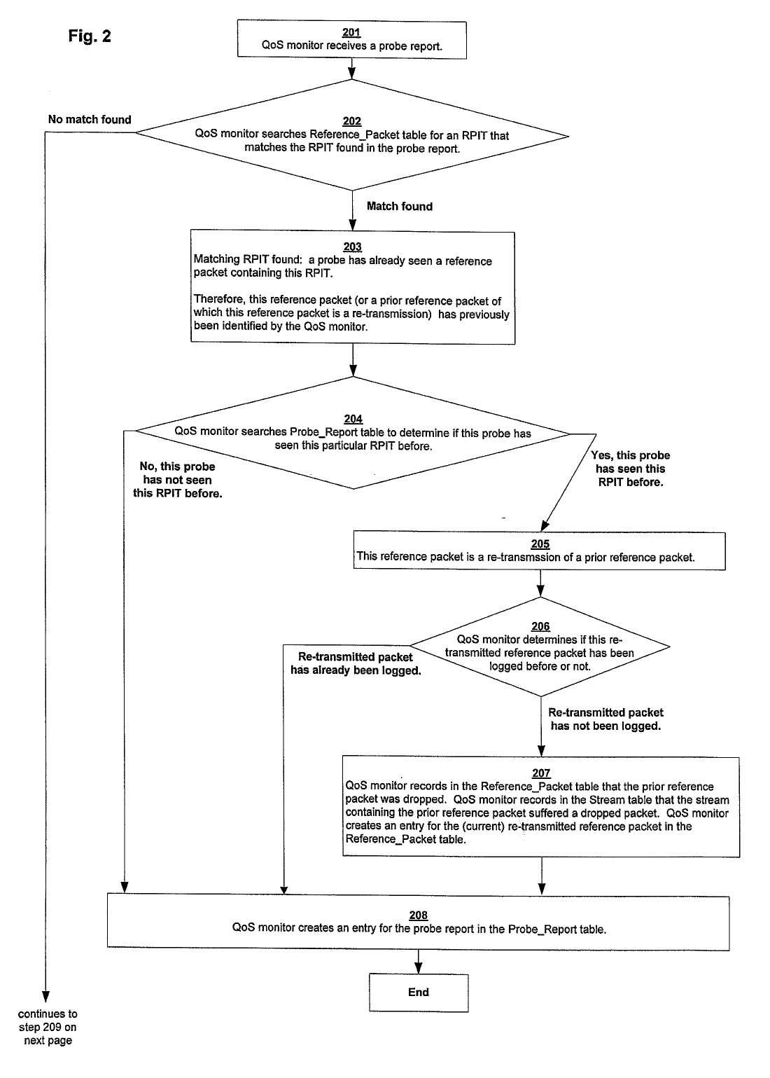

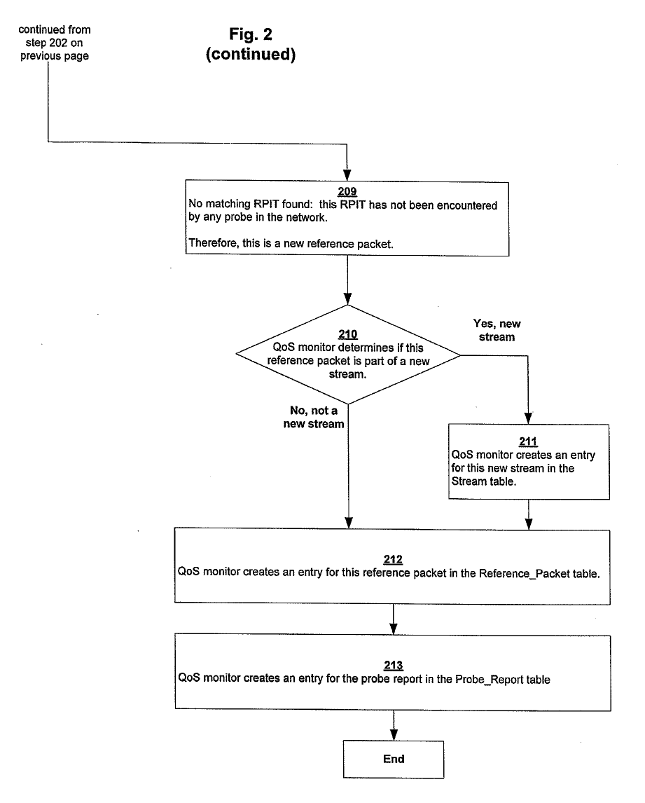

FIG. 2 is a flow-chart outlining the basic steps taken by the QoS monitor 104 for processing individual probe reports in this embodiment of the invention. (See Appendix A for detailed pseudo-code implementing these steps.)

At step 201, the QoS monitor receives a probe report.

At step 202, the QoS monitor searches for an RPIT in the Reference_Packet table that matches the RPIT contained in the probe report.

At step 203, the QoS monitor has found a matching RPIT. This either indicates 1) that the corresponding reference packet has simply traveled from one probe to another within the network 103, or 2) that the corresponding reference packet is a re-transmission of a prior reference packet and is being encountered by the current probe for the second or subsequent time.

At step 204, the QoS monitor searches the Probe_Report table to determine if this probe has seen this particular RPIT before.

At step 205, the QoS monitor determines that this probe has seen this particular RPIT before and therefore that this reference packet is a re-transmission of a prior reference packet.

At step 206, the QoS monitor will determine if this re-transmitted reference packet has been logged before or not.

At step 207, the QoS monitor will record in the Reference_Packet table that the prior reference packet was dropped. The QoS monitor will also record in the Stream table that the stream containing the prior reference packet has suffered a dropped packet. The QoS monitor will then log the (current) re-transmitted reference packet in the Reference_Packet table because it has not been logged before.

At step 208, the QoS monitor will insert an entry for the probe report in the Probe_Report table.

At step 209, the QoS monitor has determined that there is no RPIT in the Reference_Packet table that matches the RPIT in the probe report. Thus, this is the first time that any probe in the network 103 has encountered this reference packet.

At step 210, the QoS monitor determines if this new reference packet is part of a new stream by examining the New_Stream field of the probe report. The New_Stream field will be set to “true” by a probe when the probe observes a different IP source address than in prior reference packets.

At step 211, this reference packet belongs to a new stream and the QoS monitor will log the stream in the Stream table.

At step 212, the QoS monitor will log this new reference packet in the Reference_Packet table.

At step 213, the QoS monitor will log the probe report in the Probe_Report table.

Processing Performance Metrics

In addition to collecting and correlating the various probe reports, the QoS monitor 104 of the invention will periodically process the data contained in the probe reports. This processing will permit the QoS monitor 104 to present diagnostic information to the user regarding the quality of service provided by the network 103.

For instance, in one embodiment, the QoS monitor 104 will calculate the throughput and packet delay of every network segment being monitored by a probe. The QoS monitor 104 will also calculate the number and frequency of lost packets and provide that information to the user.

In some embodiments, the QoS monitor 104 will present quality of service data in a network map that visually represents the topology of the network 103. Such a map can display areas of high and low throughput, respectively, and illustrate areas of the network 103 suffering from high packet losses.

Because the QoS monitor 104 can track the various reference packets as they move throughout the network 103, the QoS monitor 104 can present a detailed view of how the various data streams are moving through the network 103. It can illustrate which areas of the network 103 receive the most traffic and which areas receive the least traffic. Using the date/time data provided by the various probes P1-P9, the QoS monitor 104 can also determine traffic trends over time. For instance, the QoS monitor 104 can determine if traffic is gradually migrating away from certain areas of the network 103 towards other areas of the network 103. The QoS monitor 104 can also determine how quickly traffic is re-routed away from heavily congested areas of the network 103 to less congested areas of the network 103. The QoS monitor 104 can accomplish all these tasks even if routers R1-R6 of the network 103 modify the IP addresses of the packets traveling over the network 103.

In some embodiments of the invention, the QoS monitor 104 can update its network statistics in real-time and alert the user in real-time whenever it has detected a dropped reference packet. In other embodiments, the QoS monitor 104 will simply store its quality of service metrics in the persistent storage device 105 for later use. Such later use could include data mining or statistical analysis.

Accordingly, while the invention has been described with reference to the structures and processes disclosed, it is not confined to the details set forth, but is intended to cover such modifications or changes as may fall within the scope of the following claims.

APPENDIX A
Psuedo-code for Processing Probe Reports

```
//Note: Reference numerals 201 - 213 correspond to like reference numerals
//of Fig. 2.
Let input be a report from a probe //201
//Check Reference_Packet table to see if we have seen this RPIT before //202
Reference_Packet_ResultSet =
  SELECT * FROM Reference_Packet WHERE Reference_Packet.RPIT = input.RPIT
if Reference_Packet_ResultSet is not NULL, then {
  //We have seen this reference packet (and this stream) before. //203
  //Check to see if this packet is a re-transmission of a dropped packet
  //i.e., check to see if **this particular probe** has seen this reference packet before
  dropped_packet_Report_Sequence_Number = //204
  SELECT max (Report_Sequence_Number)
    FROM Probe_Report
    WHERE Probe_Report.Probe_number = input.Probe_Number AND
      Probe_Report.RPIT = input. RPIT
```

| | |
|---|---|
| if dropped_packet_Report_Sequence_Number is not NULL, then { | //re-transmission |
| | //of packet //205 |

```
    //This reference packet was seen by this particular probe before. Hence, this
    //reference packet must be a re-transmission of a previous packet.
    //First, let's get a new Ref_Packet_ID. We'll use this later to record
    //the probe report (and to log the re-transmitted packet, if necessary).
    Ref_Packet_ID = new Ref_Packet_ID sequence number
    //Now let's see if this re-transmitted reference packet has already been logged
    //in the Reference_Packet table by another probe. //206
    logging_probe = SELECT Logging_Probe
      FROM Retransmitted_Reference_Packet
      WHERE Retransmitted_Reference_Packet.RPIT = input.RPIT
    /* If logging_probe is NULL, then this is the *first* time this packet has been
retransmitted and it has not been logged in the Reference_Packet table.
  If logging_probe is set to a *different* probe number, then that other probe has
already logged this re-transmitted packet and we don't have to log it again.
  If logging_probe is set to *this* probe's number, then this is the *second* or
subsequent time that the packet has been re-transmitted. We should likewise log this
re-transmission in the Reference_Packet table. */
  if logging_probe is NULL or logging_probe = input.Probe_Number, then {
    //This re-transmitted packet has not been logged in the
    //Reference_Packet table. So let's log it now. //207
      if logging_probe is NULL, then {
        //This is the *first* time this packet has been retransmitted
        INSERT into Retransmitted_Reference_Packet
              (input.RPIT, input.Probe_Number)
      }
      //Note: If logging_probe = input.Probe_Number,
      //then this is the second (or subsequent) time this reference packet has been
      //re-transmitted and this probe has already logged the prior re-transmission.
      //This probe should likewise log this re-transmission.
      //Get the Ref_Packet_ID for the (previous) dropped_packet
      dropped_packet_Ref_Packet_ID =
      SELECT Ref_Packet_ID_Fkey
        FROM Probe_Report
        WHERE Probe_Report.Probe_number = input.Probe_Number AND
          Probe_Report.Report_Sequence_Number =
            dropped_packet_Report_Sequence_Number
      //Set the Dropped flag to true in the Reference_Packet table for the previous
      //transmission of this reference packet
      UPDATE Reference_Packet set Dropped = true WHERE Ref_Packet_ID =
              dropped_packet_Ref_Packet_ID
      //Two steps to set the Dropped_Packets flag to true in the Stream table
      //for the previous transmission
      dropped_packet_Stream_ID =
      SELECT Stream_ID_Fkey
              FROM Reference_Packet
              WHERE Ref_Packet_ID = dropped_packet_Ref_Packet_ID
      UPDATE Stream SET Dropped_Packets = true WHERE Stream_ID =
            dropped_packet_Stream_ID
      //Now, it is time to insert the *current* (re-transmitted) reference packet
      //into the Reference_Packet table
      //Because this is a re-transmitted packet, it is still a part of the old stream.
      //(i.e., the Stream_ID should be set to dropped_packet_Stream_ID.)
      //Also, we must set “Dropped” to false because *this* packet has not been
      //dropped. (only the *previous* packet has been dropped so far!)
      Ref_Packet_ID = new Ref_Packet_ID sequence number
      INSERT into Reference_Packet
        (Ref_Packet_ID, input.RPIT, Dropped = false,
        dropped_packet_Stream_ID)
    } //end logging re-transmitted packet in Reference_Packet table
  //Now we insert the probe report into the Probe_Report table (regardless of
  //whether we logged the re-transmitted packet in the Reference_Packet table
  //or not.) //208
  INSERT into Probe_Report (new Report_ID sequence number, <data from input>,
                Ref_Packet_ID)
} // end re-transmission of packet
else { //We have seen this reference packet before and it has NOT been dropped.
  //Therefore, this packet has simply traveled from one probe to another in the
  //network and we should log this probe report //208
  //Get the Ref_Packet_ID for this reference packet that has been seen before
  //(by a different probe)
  Ref_Packet_ID = max(Ref_Packet_ID) from Reference_Packet_ResultSet
  //Add the probe report into the Probe_Report table
  INSERT into Probe_Report (new Report_ID sequence number, <data from input>,
                Ref_Packet_ID)
}
} //end Reference_Packet_ResultSet is not NULL
else { //Reference_Packet_ResultSet is NULL!
  //This is a new reference packet!
  //i.e., this is the first time that *any* probe has seen this reference packet. //209
  //210
  if input.New_Stream = TRUE, then { //New stream
    //create new entry in stream table //211
    Stream_ID = new Stream_ID sequence number
    INSERT into Stream (Stream_ID, <stream statistics>, Dropped_Packets = false)
  }
  else { //Existing Stream
    //Get the Stream_ID for this existing stream in two steps:
    //First, find the immediately preceding Report_Sequence_Number for this probe
    //by decrementing the current Report_Sequence_Number by one
    previous_Report_Sequence_Number = input.Report_Sequence_Number − 1
    //Second, get the Stream_ID of the immediately preceding Reference Packet
    //seen by this probe
    Stream_ID =
    SELECT Stream_ID_Fkey from Stream WHERE Ref_Packet_ID =
      (SELECT Ref_Packet_ID_Fkey from Probe_Report WHERE
        Probe_Report.Probe_number = input.Probe_Number AND
        Probe_Report.Report_Sequence_Number =
                    previous_Report_Sequence_Number)
  } //End Existing Stream
  //Regardless of whether this is a new or existing stream, we must now insert this new
  //reference packet into the Reference_Packet table and then log the probe report
  //212
  Ref_Packet_ID = new Ref_Packet_ID sequence number
  INSERT into Reference_Packet (Ref_Packet_ID, <data from input>, Stream_ID)
  //213
  INSERT into Probe_Report (new Report_ID sequence number, <data from input>,
                  Ref_Packet_ID)
} //End new reference packet
```

I claim:

1. A method for correlating data streams within a packet network comprising the steps of:
a) monitoring packets traveling over said network at a plurality of probes; and
b) independently classifying certain packets as reference packets at each of said plurality of probes.

2. The method of claim 1 wherein said classifying step further comprises the steps of:
a) monitoring a sequence number contained in each of said packets traveling over said network;
b) classifying a packet as a reference packet at each of said plurality of probes based on said monitored sequence number of said packet.

3. The method of claim 2 wherein a packet is classified as a reference packet if said monitored sequence number of said packet is a multiple of a selected value.

4. The method of claim 1 wherein said classifying step further comprises the steps of:
a) monitoring a timestamp field contained in each of said packets traveling over said network;
b) classifying a packet as a reference packet at each of said plurality of probes based on said monitored timestamp field of said packet.

5. The method of claim 4 wherein a packet is classified as a reference packet if said monitored timestamp field of said packet is a multiple of a selected value.

6. The method of claim 1 wherein said classifying step further comprises the steps of:
a) monitoring a payload tag field in the data payload contained in each of said packets traveling over said network;
b) classifying a packet as a reference packet at each of said plurality of probes based on said monitored payload tag field of said packet.

7. The method of claim 6 wherein a packet is classified as a reference packet if said monitored payload tag field of said packet matches a selected value.

8. The method of claim 7 wherein said selected value is selected from a previously monitored payload tag field of a previously monitored packet traveling over said network.

9. The method of claim 1 further comprising the step of calculating a Reference Packet Identification Tag (“RPIT”) for each of said reference packets at each of said plurality of probes.

10. The method of claim 9 wherein said calculating step utilizes a function to calculate said RPIT.

11. The method of claim 10 wherein said function utilizes the data payload of each of said reference packets as input to calculate said RPIT.

12. The method of claim 10 wherein said function utilizes the packet header of each of said reference packets as input to calculate said RPIT.

13. The method of claim 9 wherein said calculating step comprises the steps of:
a) decoding the data payload of each of said reference packets at each of said plurality of probes;
b) quantizing said decoded data payload; and
c) utilizing a function to calculate said RPIT for each of said reference packets at each of said plurality of probes using said quantized data as input to said function.

14. The method of claim 9 further comprising the step of correlating data streams within said network using said RPITs for said reference packets.

15. The method of claim 14 further comprising the step of gathering a performance metric at each of said plurality of probes.

16. The method of claim 15 further comprising the step of utilizing said performance metrics from said plurality of probes for calculating a quality-of-service metric indicating the quality-of-service provided by said network.

17. A system for correlating data streams within a packet network comprising:
a plurality of probes;
a quality-of-service monitor;
wherein each of said probes monitors packets traveling over said network;
wherein each of said probes independently classifies certain packets as reference packets; and
wherein each of said probes sends reports to said quality-of-service monitor.

18. The system of claim 17 wherein each of said probes monitors a sequence number contained in each of said packets; and
wherein said monitoring probe classifies a packet as a reference packet based on said monitored sequence number.

19. The system of claim 18 wherein said monitoring probe classifies a packet as a reference packet if said monitored sequence number of said packet is a multiple of a selected value.

20. The system of claim 17 wherein each of said probes monitors a timestamp field contained in each of said packets; and
wherein said monitoring probe classifies a packet as a reference packet based on said monitored timestamp field.

21. The system of claim 20 wherein monitoring probe classifies a packet as a reference packet if said monitored timestamp field of said packet is a multiple of a selected value.

22. The system of claim 17 wherein each of said probes monitors a payload tag field contained in each of said packets; and
wherein said monitoring probe classifies a packet as a reference packet based on said monitored payload tag field.

23. The system of claim 22 wherein said monitoring probe classifies a packet as a reference packet if said monitored payload tag field of said packet matches a selected value.

24. The system of claim 23 wherein said selected value is selected from a previously monitored payload tag field of a previously monitored packet traveling over said network.

25. The system of claim 17 wherein each of said probes calculates a Reference Packet Identification Tag (“RPIT”) for each of said reference packets.

26. The system of claim 25 wherein each of said probes calculates said RPIT utilizing a function.

27. The system of claim 26 wherein each of said probes utilizes the data payload of one of said reference packets as input to said function.

28. The system of claim 26 wherein each of said probes utilizes the packet header of one of said reference packets as input to said function.

29. The system of claim 25 wherein each of said probes decodes the data payload of each of said reference packets;
wherein each of said probes quantizes said decoded data payload; and
wherein each of said probes utilizes a function to calculate said RPIT using said quantized data as input to said function.

30. The system of claim 25 wherein said quality-of-service monitor correlates data streams within said network using said RPITs for said reference packets.

31. The system of claim 30 wherein each of said probes gathers a performance metric.

32. The system of claim 31 wherein said quality-of-service monitor utilizes said performance metrics from said plurality of probes to calculate a quality-of-service metric indicating the quality-of-service provided by said network.
